(19) United States
(12) Patent Application Publication
(10) Pub. No.: US 2026/0254056 A1
(43) Pub. Date: Aug. 27, 2026

(54) ELECTRODE ASSEMBLY AND BATTERY

(71) Applicant: Ningde Amperex Technology Limited, Ningde City (CN)

(72) Inventor: Wei Liu, Ningde City (CN)

(73) Assignee: Ningde Amperex Technology Limited, Ningde City (CN)

(21) Appl. No.: 19/549,425

(22) Filed: Feb. 25, 2026

(30) Foreign Application Priority Data
Feb. 25, 2025 (CN) 202510212918.0

(51) Int. Cl. H01M 50/491; H01M 10/04; H01M 50/434; H01M 50/457

(52) U.S. Cl. CPC H01M 50/491; H01M 10/0431; H01M 50/434; H01M 50/457

(57) ABSTRACT

An electrode assembly includes a plurality of electrode plates and a separator disposed between two of the electrode plates of opposite polarities. At least one of the electrode plates has a plurality of protrusions. The protrusions have a height H (μm). When 20≤H≤80 is satisfied, the protrusions can provide strong support to improve electrolyte infiltration effect. The separator includes a base film and a ceramic layer connected to the base film, and the ceramic layer is provided on a side of the base film along a thickness direction. The base film has a puncture strength C (gf), the ceramic layer has a thickness D1 (μm), C satisfies 100≤C≤500, and D1 satisfies 1≤D1≤6.

### CROSS REFERENCE TO RELATED APPLICATIONS

The present application claims priority to Chinese Patent Application No. 202510212918.0, filed on Feb. 25, 2025, the disclosure of which is hereby incorporated by reference in its entirety.

### TECHNICAL FIELD

This application relates to the technical field of electrochemical apparatuses, and in particular, to an electrode assembly and a battery.

### BACKGROUND

At present, an electrode assembly inside a secondary battery adopts a wound structure, hindering electrolyte infiltration into the electrode assembly. This easily leads to problems such as insufficient electrolyte and poor infiltration. In the related art, attempts have been made to apply stress to the electrode plate to cause plastic deformation thereof to form a protrusion structure, facilitating electrolyte infiltration into the electrode assembly, thereby optimizing the infiltration effect. However, in the process of constructing the protrusion structure, the electrode plate undergoes extension, which increases the risk of micro-cracks on a surface of the electrode plate and may even cause powder falling, leading to piercing of a separator and affecting safety performance of the battery.

### SUMMARY

Embodiments of this application provide an electrode assembly and a battery, which can solve the problem of poor safety performance of battery caused by powder falling from an electrode plate of an electrode assembly.

In a first aspect, an embodiment of this application provides an electrode assembly, where the electrode assembly includes a plurality of electrode plates and a separator disposed between two of the electrode plates of opposite polarities; at least one of the electrode plates has a plurality of protrusions; the protrusions have a height H (μm); and H satisfies 20≤H≤80; and the separator includes a base film and a ceramic layer connected to the base film, and the ceramic layer is provided on a side of the base film along a thickness direction; where the base film has a puncture strength C (gf), the ceramic layer has a thickness D1 (μm), C satisfies 100≤C≤500, and D1 satisfies 1≤D1≤6.

Based on an electrode assembly according to this embodiment of this application, the puncture strength C of the base film and the thickness D1 of the ceramic layer in the separator respectively satisfy the conditional expressions 100≤C≤500 and 1≤D1≤6, so that the mechanical strength of the separator is sufficient to withstand the stress generated by powder falling from the electrode plate, alleviating piercing of the separator by powder, thereby allowing for protrusions on the electrode plate. When the height H of the protrusions is in the range of 20≤H≤80, the protrusions can provide strong support to improve the electrolyte infiltration effect, thereby improving cycling performance. If C is excessively large, a shutdown temperature of the separator increases, heat generation of the cell increases at high temperature, and high-temperature storage and hot box performance of the cell deteriorate. If C is excessively small, piercing of the separator by powder cannot be avoided, reducing a processing yield rate during cell production and self-discharge performance (K value) of the cell. If D1 is excessively large, an energy density of the cell is reduced and a battery impedance is increased. If D1 is excessively small, piercing of the separator by powder cannot be avoided, reducing the processing yield rate during cell production and the self-discharge performance (K value) of the cell; and cell infiltration is deteriorated and cycling performance is deteriorated.

In some embodiments, the electrode assembly satisfies one of the following conditions: (1) C satisfies 100≤C<250, and H satisfies 20≤H<60; or (2) C satisfies 250≤C≤500, and H satisfies 60≤H≤80.

Based on the above embodiments, when the puncture strength C and the protrusion height H satisfy the above ranges, the height of the protrusions is highly adapted to the mechanical strength of the base film, mitigating the situation where a local pressure of the protrusions on the base film exceeds its tolerance limit, suppressing the piercing risk caused by powder falling from the electrode plate, thereby improving the cell processing yield rate and the self-discharge performance (K value).

In some embodiments, the electrode assembly satisfies one of the following conditions: (1) D1 satisfies 1≤D1<3, and H satisfies 20≤H<60; or (2) D1 satisfies 3≤D1≤6, and H satisfies 60≤H≤80.

Based on the above embodiments, with the thickness D1 of the ceramic layer and protrusion height H satisfying the above ranges, the height of the protrusions is highly adapted to the thickness of the ceramic layer, and the ceramic layer helps to enhance the mechanical strength of the separator to resist the stress generated by dendrites and powder particles, reducing the risk of piercing the separator.

In some embodiments, the base film has a thickness D2 (μm), and D2 satisfies 4≤D2≤14; and the base film has a porosity B (%), and B satisfies 20≤B≤55.

Based on the above embodiments, with the thickness D2 and the porosity B of the base film respectively satisfying the conditional expressions 4 μm≤D2≤14 μm and 20%≤B≤55%, the base film can maintain a certain mechanical strength to withstand the stress generated by uneven coating on the surface of the electrode plate and the protrusions.

In some embodiments, the electrode assembly satisfies one of the following conditions: (1) D2 satisfies 4≤D2<7, and H satisfies 20≤H<60; or (2) D2 satisfies 7≤D2≤14, and H satisfies 60≤H≤80.

Based on the above embodiments, with the thickness D2 of the base film and the protrusion height H satisfying the above ranges, the thickness of the base film is highly adapted to the height of the protrusions, enabling the base film to form an effective barrier, reducing the risk of short circuit due to contact between positive and negative electrode plates, and maintaining the structural stability of the battery. Further, through gradient matching, the base film has an appropriate internal resistance, avoiding unnecessary loss of energy density and power density of the battery due to matching between low protrusions and a thick base film.

In some embodiments, the electrode assembly satisfies one of the following conditions: (1) B satisfies 40≤B≤55, and H satisfies 20≤H<60; or (2) B satisfies 20≤B<40, and H satisfies 60≤H≤80.

Based on the above embodiments, with the porosity B of the base film and the protrusion height H satisfying the above ranges, air permeability of the separator can be improved, thereby improving ion transport performance; and the base film, as a good carrier in electrolyte infiltration, can store electrolyte through pores.

In some embodiments, at least one of the plurality of electrode plates is a negative electrode plate; and the separator includes one or two ceramic layers, and along the thickness direction of the base film, at least one ceramic layer is provided on a side of the base film facing the negative electrode plate.

Based on the above embodiments, a ceramic layer is provided on the side of the base film facing the negative electrode plate. The ceramic layer has a certain electrolyte absorption capacity, and can absorb and retain more electrolyte to enhance an electrolyte retention capacity of the negative electrode plate, facilitating the diffusion and intercalation of lithium ions in the negative electrode plate, thereby improving the cycling performance of the battery.

In some embodiments, the separator further includes an adhesive layer, the adhesive layer is adhered to the base film or the ceramic layer, and the adhesive layer is further configured for adhesive connection to the electrode plate; where the adhesive layer has a thickness D3 (μm), and the electrode assembly satisfies one of the following conditions: (1) D3 satisfies 0.5≤D3<2, and H satisfies 20≤H<60; and (2) D3 satisfies 2≤D3≤5, and H satisfies 60≤H≤80.

Based on the above embodiments, with the thickness D3 of the adhesive layer and protrusion height H satisfying the above ranges, the adhesive layer has an appropriate thickness and good adhesive performance to improve the contact interface between the separator and the electrode plate; and the adhesive layer can buffer the local pressure caused by the protrusions, reducing the risk of piercing the separator, ensuring good K value performance.

In some embodiments, the adhesive layer is a porous structure, the adhesive layer has a pore size P (μm), and the protrusions have a diameter R (mm); and the electrode assembly satisfies one of the following conditions: (1) 100<P≤300, 20≤H<60, and 0.3 mm≤R<2 mm; or (2) 0.5≤P≤100, 60≤H≤80, and 2 mm<R≤10 mm.

Based on the above embodiments, with the pore size P of the adhesive layer, the protrusion height H, and the diameter R satisfying the above ranges, the air permeability and mechanical performance of the adhesive layer are balanced, thereby improving the ion transport performance and puncture resistance of the separator. In addition, it is convenient to control an area occupied by the protrusions within an appropriate range, preventing a sharp shape of the protrusions from damaging the separator, and preventing the area occupied by the protrusions from being excessively large, which results in an insufficient infiltration space after winding.

In some embodiments, the electrode plate includes a main body, and the protrusion is formed by a portion of the electrode plate protruding toward a side in a thickness direction of the main body; and in a thickness direction of the electrode plate, all the protrusions are bent toward a same side of the main body; or in a thickness direction of the electrode plate, some protrusions are bent toward a side of the main body, and other protrusions are bent toward another side of the main body.

Based on the above embodiments, the plurality of protrusions on the electrode plate may be provided on a same side or different sides of the main body, to facilitate the setting of an orientation of the protrusions based on an actual structure of the electrode assembly, providing uniform support to the separator.

In a second aspect, an embodiment of this application provides a battery, including a case and the electrode assembly described above, where the electrode assembly is provided in an internal space of the case.

Based on an electrode assembly and a battery according to some embodiments of this application, the puncture strength C (gf) of the base film and the thickness D1 (μm) of the ceramic layer respectively satisfy the conditional expressions 100≤C≤500 and 1≤D1≤6, so that the mechanical strength of the separator is sufficient to withstand the stress generated by the protrusions and powder falling from the electrode plate, helping to alleviate piercing of the separator, reducing the risk of short circuit, increasing the electrode assembly yield rate. In this way, the electrode plate can be processed to form the protrusions satisfying usage requirements, improving the electrolyte infiltration effect, and helping to prolong the service life and stability of the battery.

### BRIEF DESCRIPTION OF DRAWINGS

To more clearly illustrate some embodiments of this application or the technical solutions in the prior art, the drawings needed in the description of these embodiments or the prior art are briefly introduced below. It is clear that the drawings in the following description are only some embodiments of this application. For those skilled in the art, other drawings can also be obtained according to these drawings without creative efforts.

FIG. 1 is a schematic front view of a structure of an electrode plate in an unfolded state according to an embodiment of this application;

FIG. 2 is a schematic cross-sectional view of a structure of an electrode assembly according to an embodiment of this application;

FIG. 3 is a schematic diagram of a structure of a separator according to an embodiment of this application;

FIG. 4 is a schematic diagram of a structure of a protrusion according to an embodiment of this application; and

FIG. 5 is a schematic diagram of a structure of a separator according to another embodiment of this application.

### REFERENCE SIGNS

10. electrode plate; 11. positive electrode plate; 12. negative electrode plate; 101. protrusion; 102. main body;
20. separator; 21. base film; 22. ceramic layer; 23. adhesive layer;
X. length direction of an electrode plate; Y. width direction of an electrode plate; and Z. thickness direction of an electrode plate.

### DETAILED DESCRIPTION

To make the purpose, technical solutions and advantages of this application clearer, this application will be further described in detail below with reference to the drawings and embodiments. It should be understood that the specific embodiments described herein are only used to explain this application and are not used to limit this application.

The inventor has found that for an electrode assembly of a wound structure inside a secondary battery, the electrode assembly undergoes hot-pressing after electrode plates and a separator are alternately stacked and wound; internal stress inside the electrode assembly results in poor electrolyte infiltration; and the electrode assembly swells during charge and discharge, further aggravating interlayer extrusion of the electrode assembly, and thus resulting in insufficient electrolyte, poor infiltration, and ultimate deterioration of an interface at weak positions, and even lithium precipitation. To solve the above problems, gaps need to be created between battery layers. Currently, the following methods are used to create gaps. (1) Attach adhesive tape at specific positions of the electrode plate to provide support and form gaps. This currently improves infiltration, but a thickness of the adhesive tape increases a thickness of the electrode assembly and causes a certain loss of energy density of the battery. (2) Apply soluble chemical substances: uniformly apply some glue soluble in electrolyte to the electrode plate, to form gaps. The improvement effect is limited, and side effects affect battery performance. (3) Thicken a separator. This strengthens an electrolyte storage capacity of the separator and improves the electrolyte infiltration effect to some extent, but this method thickens the battery and causes grate loss of energy density.

The inventor has also found that by providing protrusions that provide support during winding on the electrode plate, gaps form between the electrode plate layers of the electrode assembly, thereby improving a transport capacity of the electrolyte inside the electrode assembly and improving cycling performance of the battery. In actual processing, protrusions are formed by applying stress to the electrode plate to cause plastic deformation thereof. In this case, the electrode plate undergoes extension, and a higher extension rate of the electrode plate indicates greater damage to the electrode plate, a higher possibility of micro-cracks on a surface of the electrode plate, and a greater risk of powder falling from the electrode plate and piercing of the separator by the powder, affecting the safety performance of the battery. Based on this, some embodiments of this application provide an electrode assembly and a battery, in which a separator is designed to improve a yield rate and safety performance of the electrode assembly with protrusions.

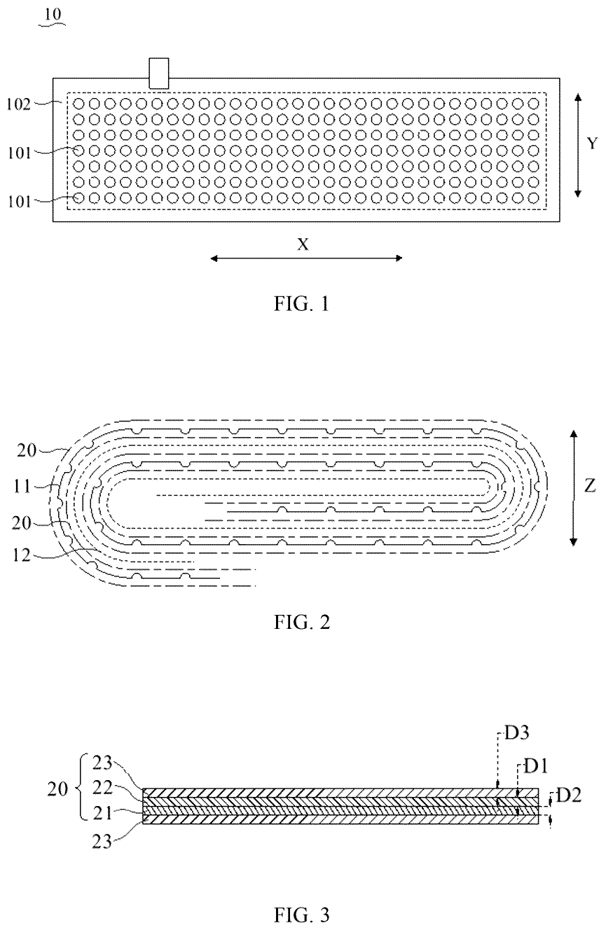

The battery in some embodiments of this application includes a case and an electrode assembly provided in an internal space of the case, and includes electrolyte filling the internal space of the case. The electrode assembly includes two electrode plates of opposite polarities and a separator. Refer to FIG. 1 and FIG. 2. The electrode plate 10 has a length direction X, a width direction Y and a thickness direction Z that are perpendicular to each other. Length directions X, width directions Y, and thickness directions Z of the two electrode plates 10 of opposite polarities of the electrode assembly are consistent. The separator 20 is provided between the two electrode plates 10 of opposite polarities in the thickness direction Z of the electrode plate 10. One of the two electrode plates 10 of opposite polarities is a positive electrode plate 11 and the other is a negative electrode plate 12. The separator 20 has an insulation property to separate the positive electrode plate 11 and the negative electrode plate 12, to prevent short circuit between the positive electrode plate 11 and the negative electrode plate 12. In these embodiments of this application, the positive electrode plate 11 and the negative electrode plate 12 are not particularly limited, and various electrode plates known in the art that can be used as positive and negative electrodes are applicable to this application.

Refer to FIG. 3. The separator 20 includes a base film 21 and a ceramic layer 22 connected to the base film 21. The ceramic layer 22 is provided on a side of the base film 21 along a thickness direction. In some embodiments of this application, a puncture strength C of the base film 21 and a thickness D1 of the ceramic layer 22 are coordinately controlled, so that the separator 20 has sufficient mechanical strength to block powder particles that may be caused by constructing protrusions 101, with little influence on an internal resistance of the electrode assembly. In this way, the protrusions 101 can be constructed on the electrode plate 10, to improve the electrolyte infiltration effect under the premise of ensuring the safety performance of the electrode assembly.

The base film 21 has the puncture strength C (gf), and C satisfies 100≤C≤500, for example, C may be 100, 200, 300, 400, or 500, or may be in any range therebetween. The base film 21 is in the above conditional expression, so that the base film 21 has sufficient mechanical strength. When the separator 20 is sandwiched between uneven electrode plates 10, the base film 21 can withstand the stress generated by powder falling from the electrode plate 10, reducing the risk of piercing the separator 20. When C is higher than the upper limit of 500, the base film 21 requires a high-density material, the thickness increases, and the internal resistance of the electrode assembly increases accordingly, affecting the electrochemical performance of the battery. When Cis lower than the lower limit of 100, the effect of protecting the base film 21 from powder particles is limited, increasing the probability of local perforation of the separator 20, which easily causes short circuit.

The ceramic layer 22 has a thickness D1 (μm), and D1 satisfies 1≤D1≤6, for example, D1 may be 1, 3, 5, or 6, or may be in any range therebetween. The ceramic layer 22 is in the above conditional expression, so that the ceramic layer 22 can resist the piercing by powder particles. With the ceramic layer 22, the separator 20 has better electrolyte affinity, helping to improve thermal stability of the separator 20. This ensures good cycling stability of the battery. When D1 is higher than the upper limit of 6, the ceramic layer 22 is excessively thick and flexibility decreases. In this case, a mass and thickness of the separator 20 are increased, which is not conducive to the improvement of the energy density of the battery; further, a probability of wrinkling during processing and winding may increase, affecting the yield rate of the electrode assembly. When D1 is lower than the lower limit of 1, the ceramic layer 22 is excessively thin, and therefore the assistance to the mechanical strength of the separator 20 is limited, increasing the difficulty in effectively resisting the piercing by dendrites and powder particles falling from the electrode plate 10.

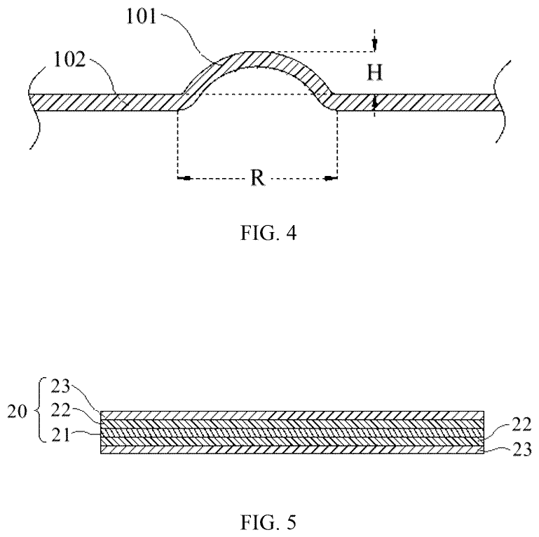

Refer to FIG. 4. At least one of the positive electrode plate 11 and the negative electrode plate 12 has protrusions 101, where the protrusions 101 have a height H (μm), and H satisfies 20≤H≤80, for example, H may be 20, 40, 60, or 80, or may be in any range therebetween. The protrusions 101 are in the above conditional expression, so that the protrusions 101 provide support for the separator 20, forming a gap between the separator 20 and the electrode plate 10 for smooth flow of the electrolyte between the protrusions 101. This achieves better electrolyte retention, improving the electrolyte infiltration effect, and preventing local electrolyte shortage. When H is higher than the upper limit of 80, the protrusions 101 are excessively high, and part of the electrode plate 10 is excessively extended, which easily causes structural damage to the electrode plate 10, for example, structural defects such as cracks in an active material layer or breakage of a current collector. When H is lower than 20, the protrusions 101 are excessively low, leading to an insufficient support ability of the protrusions 101, limiting the improvement of the electrolyte infiltration effect.

In some embodiments, the electrode plate 10 includes a main body 102, where a portion of the electrode plate 10 protrudes toward a side in a thickness direction of the main body 102 to form the protrusions 101. Optionally, in the thickness direction Z of the electrode plate 10, all protrusions 101 provided on a single electrode plate 10 are bent toward a same side of the main body 102. For example, all protrusions 101 provided on a single electrode plate 10 protrude toward a side where a winding center is located, or all protrusions 101 provided on a single electrode plate 10 protrude toward a side away from the winding center. Optionally, in the thickness direction Z of the electrode plate 10, some protrusions 101 provided on a single electrode plate 10 are bent toward a side of the main body 102, and other protrusions 101 are bent toward another side of the main body 102. For example, some protrusions 101 provided on a single electrode plate 10 are bent toward a side where the winding center is located, and other protrusions 101 are bent toward a side away from the winding center.

The above descriptions are only exemplary descriptions. An orientation of the protrusions 101 of each electrode plate 10 is not limited in this application, and may be specifically determined according to actual needs.

In the separator 20, the base film 21 provides physical isolation to prevent short circuit caused by direct contact between the positive and negative electrode plates, while allowing lithium ions to shuttle freely. The base film 21 can resist mechanical deformation such as swelling of the electrode plate 10 and winding stress, providing mechanical support for the separator 20. The puncture strength of the base film 21 is C, satisfying 100≤C<250; and the height H of the protrusions 101 satisfies 20≤H<60. The base film 21 with a relatively low puncture strength C matches the protrusions 101 with a relatively low height H, ensuring that the base film 21 has sufficient mechanical strength to cope with the stress generated by the protrusions 101 and powder particles, reducing toughness loss of the base film 21 and reducing a risk of cracking of the base film 21. The puncture strength of the base film 21 is C, satisfying 250≤C≤500; and the height H of the protrusions 101 satisfies 60≤H≤80. The base film 21 with a relatively high puncture strength C copes with stress concentration generated by relatively high protrusions 101, thereby reducing the short circuit risk.

C and H satisfy the above ranges, so that the height of the protrusions 101 is highly adapted to the mechanical strength of the base film 21, mitigating the situation where a local pressure of the protrusions 101 on the base film 21 exceeds its tolerance limit, and suppressing the piercing risk caused by powder falling from the electrode plate 10. In addition, when C satisfies 100≤C<250 and H is higher than the upper limit of 60, or when C satisfies 250≤C≤500 and His higher than the upper limit of 80, the pressure of the protrusions 101 exceeds the puncture resistance limit of the base film 21, increasing the risk of rupture of the base film 21, which may lead to micro-cracks in the base film 21. When C satisfies 100≤C<250 and His lower than the lower limit of 20, the height of the protrusions 101 is insufficient to form an effective gap, and therefore a cross-sectional area for the electrolyte flow decreases, leading to longer infiltration time, easily causing local lithium precipitation. When C satisfies 250≤C≤500 and His lower than the lower limit of 60, the material performance of the base film 21 is wasted, and utilization of its compression resistance is low.

Optionally, the base film 21 may be a polyolefin film, such as a polyethylene (PE, Polyethylene) film, a polypropylene (PP, Polypropylene) film, or the like, and the base film 21 may be a single-layer film or a multi-layer composite film, which is not limited herein.

In these embodiments of this application, the base film 21 has a thickness D2 (μm), and D2 satisfies 4≤D2≤14, for example, D2 may be 4, 8, 12, or 14, or may be in any range therebetween. In the above thickness range, the base film 21 may form a barrier between the adjacent electrode plates 10, and the base film 21 may maintain a certain mechanical strength to withstand the stress generated by uneven coating on the surface of the electrode plate 10 and the protrusions 101.

In some embodiments, D2 satisfies 4≤D2<7, and H satisfies 20≤H<60. This ensures that while the base film 21 has sufficient mechanical strength to cope with the protrusions 101 and powder particles, a thinner base film 21 helps improve the energy density of the battery. When D2 satisfies 7≤D2≤14, and H satisfies 60≤H≤80, the base film 21 has higher mechanical strength, thereby allowing for higher protrusions 101 on the electrode plate 10, further improving the electrolyte infiltration effect. With D2 and H satisfying the above ranges, the thickness of the base film 21 is highly adapted to the height of the protrusions 101, enabling the base film 21 to form an effective barrier, reducing the risk of short circuit due to contact between positive and negative electrode plates, maintaining the structural stability of the battery. Further, through gradient matching, the base film 21 has an appropriate internal resistance, avoiding unnecessary loss of energy density and power density of the battery due to matching between low protrusions 101 and a thick base film 21. When D2 satisfies 4≤D2<7 and His lower than the lower limit of 20, or when D2 satisfies 7≤D2≤14 and His lower than the lower limit of 60, the thickness of the base film 21 is redundant relative to the height of the protrusions 101, increasing the internal resistance of the battery, deteriorating the chemical performance of the battery, and hindering the improvement of the energy density of the battery. When D2 satisfies 4≤D2<7 and His higher than the upper limit of 60, or when D2 satisfies 7≤D2≤14 and His higher than the upper limit of 80, the base film 21 is relatively excessively thin and easily pierced by dendrites and powder particles.

In these embodiments of this application, the base film 21 has a porosity B (%), and B satisfies 20≤B≤55, for example, B may be 20, 30, 40, 50, or 55, or may be in any range therebetween. When the porosity of the base film 21 is within the above range, air permeability of the separator 20 can be improved, thereby improving ion transport performance; and the base film 21, as a good carrier in electrolyte infiltration, can store electrolyte through pores.

In some embodiments, B satisfies 40≤B≤55, and H satisfies 20≤H<60. This ensures that the base film 21 has sufficient mechanical strength to cope with the protrusions 101 and powder particles, and the base film 21 has good air permeability to improve the electrochemical performance of the battery. When B satisfies 20≤B<40, and H satisfies 60≤H≤80, the base film 21 has higher mechanical strength, thereby allowing for higher protrusions 101 on the electrode plate 10. With B and H satisfying the above ranges, pores uniformly distributed in the base film 21 can promote uniform ion transport, ensuring consistency of the interface performance between the electrode plate 10 and the electrolyte, reducing generation of lithium dendrites, thereby improving the safety of the battery. When B satisfies 40≤B≤55 and His higher than the upper limit of 60, or when B satisfies 20≤B<40 and His higher than the upper limit of 80, the porosity of the base film 21 is relatively excessively high, resulting in a decrease in the mechanical strength of the base film 21, affecting the safety of the battery. When B satisfies 40≤B≤55 and His lower than the lower limit of 20, or when B satisfies 20≤B<40 and H is lower than the lower limit of 60, the porosity of the base film 21 is relatively excessively low, resulting in a low electrolyte absorption rate and a large internal resistance of the battery. This is not conducive to lithium ion transport.

In the separator 20, the ceramic layer 22 is configured to block powder particles or prevent dendrites from piercing the base film 21, to strengthen the mechanical performance of the separator 20; and the ceramic layer 22 can inhibit contraction of the base film 21 at high temperature and prevent thermal runaway. The introduction of the ceramic layer 22 can improve the mechanical strength and thermal stability of the separator 20, thereby improving the safety performance of the battery. In some embodiments, the thickness D1 (μm) of the ceramic layer 22 satisfies 1≤D1<3, and the height of the protrusions 101 satisfies 20≤H<60. The thickness D1 (μm) of the ceramic layer 22 satisfies 4≤D2≤14, and the height of the protrusions 101 satisfies 60≤H≤80. With D1 and H satisfying the above ranges, the height of the protrusions 101 is highly adapted to the thickness of the ceramic layer 22, and the ceramic layer 22 helps to enhance the mechanical strength of the separator 20 to resist the stress generated by dendrites and powder particles, reducing the risk of piercing the separator 20. In addition, when D1 satisfies 1≤D1<3 and His higher than the upper limit of 60, or D1 satisfies 4≤D2≤14 and H is higher than the upper limit of 80, the ceramic layer 22 barely provides effective protection, and the protrusions 101 squeeze the ceramic layer 22, generating the local stress that easily causes the ceramic layer 22 to fall off, resulting in deterioration of interface contact. When D1 satisfies 1≤D1<3 and His lower than the lower limit of 20, lower protrusions 101 cannot form an effective gap, hindering electrolyte flow, and increasing the risk of local lithium precipitation. When D1 satisfies 4≤D2≤14 and His lower than the lower limit of 60, a relatively thicker ceramic layer 22 does not match high protrusions 101, resulting in low utilization of compression resistance, and an excessively thick ceramic layer 22 hinders the improvement of the energy density of the battery.

Optionally, a material of the ceramic layer 22 includes at least one of alumina, titania, zinc oxide, zirconia, magnesia, titanium dioxide, silica, or calcium oxide.

In some embodiments, the separator 20 includes one or two ceramic layers 22. Along the thickness direction of the base film 21, at least one ceramic layer 22 is provided on a side of the base film 21 facing the negative electrode plate 12. The ceramic layer 22 has a certain electrolyte absorption capacity, and can absorb and retain more electrolyte to enhance an electrolyte retention capacity of the negative electrode plate 12, facilitating the diffusion and intercalation of lithium ions in the negative electrode plate 12, thereby improving the cycling performance of the battery. It can be understood that since the ceramic layer 22 has certain thermal and electrical insulation properties, providing the ceramic layer 22 on the side of the base film 21 facing the negative electrode plate 12 can reduce the risk of lithium precipitation under overcharge condition of the battery and alleviate the excessive intercalation and deintercalation of lithium ions. During the long-term cycling of the battery, lithium dendrites may form on the surface of the negative electrode plate 12, and the ceramic layer 22 can alleviate the formation of lithium dendrites and reduce the piercing risk.

Optionally, if the separator 20 is provided with one ceramic layer 22, in the thickness direction of the base film, the ceramic layer 22 is provided on the side of the base film 21 facing the negative electrode plate 12. As shown in FIG. 5, the separator 20 is provided with two ceramic layers 22, and in the thickness direction of the base film, the two ceramic layers 22 are respectively provided on two opposite sides of the base film 20.

In some embodiments, the ceramic layer 22 includes ceramic particles, the ceramic particles have a particle size E (μm), and the electrode assembly satisfies one of the following conditions:

$$\\ \begin{matrix}E satisfies 1 < E \leq 2 , and H satisfies 20 \leq H < 60 ; or & ( 1 )\end{matrix}$$

$$\\ \begin{matrix}E satisfies 0.1 \leq E \leq 1 , and H satisfies 60 \leq H \leq 80. & ( 2 )\end{matrix}$$

With E and H satisfying the above ranges, the ceramic particles stack to form a high-strength ceramic layer 22 to resist the local stress caused by the protrusions 101 and the mechanical penetration of powder particles, reducing the risk of failure of the separator 20. In addition, the uniform arrangement of ceramic particles forming the uniform ceramic layer facilitates uniform heat distribution in the electrode assembly, and improves thermal stability of the separator 20. Further, uniform pore size distribution leads to more uniform lithium flux and lithium deposition, alleviating the generation of lithium dendrites. On this basis, when E satisfies 1<E≤2, the particle size of the ceramic particles is relatively large, and the rough surface morphology of the ceramic layer 22 helps to improve the electrolyte infiltration of the separator 20, helping to improve battery performance. When E satisfies 0.1≤E≤1, the particle size of the ceramic particles is relatively small, and a stacking density is relatively high, so that a dense and high-strength ceramic layer 22 is formed. This helps to improve the mechanical strength of the ceramic layer 22, thereby allowing for higher protrusions 101.

In some embodiments, the ceramic layer 22 further includes a binder, and the binder enables tight connection between the ceramic layer 22 and the base film 21. It should be noted that the ceramic layer 22 is not limited to the above components, and those skilled in the art can select other components used in the related art for preparing the ceramic layer 22 according to actual needs, in other words, the ceramic layer 22 may further include other additives, such as a dispersant (organic acid).

In these embodiments of this application, the separator 20 further includes an adhesive layer 23. The adhesive layer 23 is adhered to the base film 21 or the ceramic layer 22, and the adhesive layer 23 is also adhered to the electrode plate 10. The adhesive layer 23 is formed on an outermost layer of the separator 20, so that the separator 20 and the electrode plate 10 are tightly connected to each other, preventing delamination between the two during winding. For example, the separator 20 is provided with one ceramic layer 22 and two adhesive layers 23, where the ceramic layer 22 is provided on a side of the base film 21 facing the negative electrode plate 12 in the thickness direction of the base film 21; one adhesive layer 23 is adhered between the ceramic layer 22 and the negative electrode plate 12; and the other adhesive layer 23 is adhered between the base film 21 and the positive electrode plate 11. For another example, the separator 20 is provided with two ceramic layers 22 and two adhesive layers 23, where the ceramic layers 22 are respectively provided on two sides of the base film 21 along the thickness direction, and the adhesive layers 23 adhere to the ceramic layer 22 and the electrode plate 10.

Optionally, a material of the adhesive layer 23 includes at least one of polyvinylidene fluoride, polyacrylonitrile, polyacrylic acid, or polystyrene.

In some embodiments, the adhesive layer 23 has a thickness D3 (μm), and the electrode assembly satisfies one of the following conditions:

$$\\ \begin{matrix}D 3 satisfies 0.5 \leq D 3 < 2 , and H satisfies 20 \leq H < 60 ; or & ( 1 )\end{matrix}$$

$$\\ \begin{matrix}D 3 satisfies 2 \leq D 3 \leq 5 , and H satisfies 60 \leq H \leq 80. & ( 2 )\end{matrix}$$

With D3 and H satisfying the above ranges, the adhesive layer 23 has an appropriate thickness and good adhesive performance to improve the contact interface between the separator 20 and the electrode plate 10, and improve the consistency of the battery; and the adhesive layer 23 can buffer the local pressure caused by the protrusions 101, reducing the risk of piercing the separator 20. When D3 satisfies 0.5≤D3<2 and His lower than the lower limit of 20, or D3 satisfies 2≤D3≤5 and H is lower than the lower limit of 60, the adhesive layer 23 is relatively thick, hindering the electrolyte infiltration, resulting in reduced ion conductivity; and an excessively thick adhesive layer 23 easily leads to loose cross-sectional bonding between the electrode plate 10 and the separator 20, deterioration of interface contact, and increased impedance. When D3 satisfies 0.5≤D3<2 and His higher than the upper limit of 60, or D3 satisfies 2≤D3≤5 and His higher than the upper limit of 80, the adhesive layer 23 is relatively thin, hardly ensuring the adhesive effect, and adhesive failure of the adhesive layer 23 may cause damage to the electrode plate 10, accelerating the expansion of micro-cracks in the electrode plate 10, resulting in more serious powder falling problems.

In some embodiments, the adhesive layer 23 is a porous structure, the adhesive layer 23 has a pore size P (μm), and the protrusions 101 have a diameter R (mm). The electrode assembly satisfies one of the following conditions:

$$100 < P \leq 300 , 20 \leq H < 60 , and 0.3 \leq R < 2 ; \qquad ( 1 )$$

$$or$$

$$0.5 \leq P \leq 100 , 60 \leq H \leq 80 , and 2 < R \leq 10. \qquad ( 2 )$$

With P, H and R satisfying the above ranges, the air permeability and mechanical performance of the adhesive layer 23 are balanced, thereby improving the ion transport performance and puncture resistance of the separator 20. In addition, within the above ranges, it is convenient to control an area occupied by the protrusions 101 within an appropriate range, preventing the area occupied by the protrusions 101 from being excessively large or small, which makes it difficult to balance the electrolyte infiltration and support strength requirements; and the height of the protrusions 101 is considered to prevent a sharp shape of the protrusions 101 from damaging the separator 20, preventing the area occupied by the protrusions 101 from being excessively large, which results in an insufficient infiltration space after winding.

In some embodiments, the adhesive layer 23 includes adhesive particles, the adhesive particles have a particle size G (μm), and the electrode assembly satisfies one of the following conditions:

$$G satisfies 0.2 \leq G < 1 , and H satisfies 20 \leq H < 40 ; \qquad ( 1 )$$

$$G satisfies 1 \leq G \leq 5 , and H satisfies 40 \leq H < 60 ; \qquad ( 2 )$$

$$or$$

$$G satisfies 5 < G \leq 30 , and H satisfies 60 \leq H \leq 80. \qquad ( 3 )$$

The adhesive layer 23 includes a copolymer, and the copolymer is in a particle form, that is, the above adhesive particle. With G and H satisfying the above ranges, the copolymer may form particle protrusions in the adhesive layer 23, forming a certain gap when the separator 20 and the electrode plate 10 are in contact, to buffer the swelling and deformation of the battery during use. When G satisfies 0.2≤G<1 and His lower than the lower limit of 20, or G satisfies 1≤G≤5 and H is lower than the lower limit of 40, or G satisfies 5<G≤30 and His lower than the lower limit of 60, the relatively large particle size of the adhesive particles not only affects the adhesive effect of the adhesive layer 23, but also leads to an excessively thick adhesive layer 23, increasing the space occupied by the separator 20 and reducing the energy density of the battery. When G satisfies 0.2≤G<1 and H is higher than the upper limit of 40, or G satisfies 1≤G≤5 and His higher than the upper limit of 60, or G satisfies 5<G≤30 and His higher than the upper limit of 80, the relatively small particle size of the adhesive particles makes it difficult to form a gap between the separator 20 and the electrode plate 10. Therefore, there is no buffer space for the swelling of the electrode plate 10 during charge and discharge of the battery, and then the interface pressure is directly transmitted to the separator 20, accelerating the fatigue rupture of the film material.

Some embodiments of this application further provide a battery. The battery includes a case and the above electrode assembly. The electrode assembly is provided in an internal space of the case. The battery further includes an electrolyte. The electrolyte fills the internal space of the case and infiltrates into the electrode assembly. The electrolyte is not particularly limited in these embodiments of this application, and various materials known in the art that can be used as electrolyte are applicable to this application.

An electrode assembly of a lithium-ion battery is taken as an example below to further illustrate this application with reference to specific examples. It should be understood that these examples are only used to illustrate this application and are not used to limit the scope of this application.

In each example and comparative example of this application, the following methods are used to prepare lithium-ion batteries and test the lithium-ion batteries.

### (1) Cycling Test at 25° C./45° C.

In an environment of 25° C./45° C., the electrode assembly was charged at a constant current of 3C to a full charge voltage (the maximum voltage designed for the battery was 4.53V), then charged at a constant voltage at the maximum voltage to the current of 0.02C, and then discharged at a constant current of 0.5C to the final voltage of 3.0V. A discharge capacity of the first cycle was recorded. Then the above steps were repeated for 1000/800 charge-discharge cycles, and discharge capacities of the lithium-ion battery after 1000/800 charge-discharge cycles were recorded as follows:

$$3 C charge / 0.5 C discharge cycling capacity retention rate at 25 ° C . = ( discharge capacity of the 1000 th cycle / discharge capacity of the first cycle ) \times 100 \% ;$$

$$3 C charge / 0.5 C discharge cycling capacity retention rate at 45 ° C . = ( discharge capacity of the 800 th cycle / discharge capacity of the first cycle ) \times 100 \% ;$$

$$3 C charge / 0.5 C discharge cycling capacity retention rate at 55 ° C . = ( discharge capacity of the 800 th cycle / discharge capacity of the first cycle ) \times 100 \% ;$$

$$and$$

$$3 C charge / 0.5 C discharge cycling capacity retention rate at 65 ° C . = ( discharge capacity of the 800 th cycle / discharge capacity of the first cycle ) \times 100 \% .$$

### (2) Winding Yield Rate

After bare cell winding was completed, an X-Ray detector was used to detect the overhang of bare cells (in a width direction of a positive electrode plate, a width of a negative electrode plate edge exceeded an edge of the positive electrode plate). A product with the overhang greater than 0.2 mm was a good product. A total of tested samples was 100, where winding yield rate=good product quantity/total sample quantity.

### (3) Test Method for K Value

After the cell production was completed, an open circuit voltage tester was used to first measure an open circuit voltage OCV1 of the cell, and after an interval of 48 h, an open circuit voltage OCV2 of the cell was measured again, where K value=(OCV1−OCV2) mv/48 h.

The K value may characterize self-discharge performance of the cell. A larger K value indicated a faster battery power drop, that is, the battery power dropped faster when the battery was in a stationary state. A smaller K value indicated a slower battery power drop, meaning that the battery had good stability, that is, the battery power dropped slower when the battery was in a stationary state.

### (4) Test Method for Puncture Strength

The prepared base film was laid flat in a fixture and clamped. A piercing needle with a diameter of 1 mm and a spherical tip with a spherical diameter of 0.5 mm was used for piercing at a rate of (100±10) mm/min. A force F₀ measured when the base film was pierced was recorded. The pierced sample was taken out, four points around the pinhole were tested for thicknesses, and an average value s̅ was calculated, where puncture strength C was calculated as C=F₀/s̅.

### (5) Test Method for Porosity

Three samples were obtained through cutting the base film at intervals of 150 mm in a longitudinal direction. The sample size was 100 mm×80 mm. Length L1, width L2, and thickness L3 of the samples were measured. A mass M of the sample was weighed with an analytical balance with a resolution of 0.0001 g, and an areal density ρ₁ and a porosity B of the sample was calculated as follows:

$$ρ = M ( L 1 \times L 2 ) ;$$

$$and$$

$$B = ( 1 - {ρ}_{1} / L 3 \times {ρ}_{0} ) ) \times 100 \% ;$$

where ρ₀ was the density of a raw material.

### Example 1-1

### Preparation of Lithium-Ion Battery

### (1) Preparation of Positive Electrode Plate

A positive electrode active material lithium cobalt oxide LiCoO₂, a conductive agent conductive carbon black, and a binder polyvinylidene fluoride PVDF were mixed in a mass ratio of 97.9:0.9:1.2, with N-methylpyrrolidone NMP added as a solvent; and uniformly stirred under the action of a vacuum mixer to obtain a positive electrode slurry with a solid content of 75 wt %. The positive electrode slurry was uniformly applied to a surface of a positive current collector aluminum foil with a thickness of 9 μm, dried at 85° C., and cold-pressed to obtain a positive electrode with a single side coated with a positive electrode material layer with a thickness of 95 μm. Then, the above steps were repeated on another surface of the aluminum foil to obtain a positive electrode with two sides coated with positive electrode material layers. After cutting and welding a positive electrode tab, which was an aluminum tab, a positive electrode plate with a specification of 74 mm×851 mm was obtained, and a compacted density of the positive electrode material layer of the positive electrode plate was 4.20 g/cm³.

### (2) Preparation of Negative Electrode Plate

A negative electrode active material artificial graphite, a binder styrene-butadiene rubber SBR, and a thickener sodium carboxymethyl cellulose CMC were mixed in a mass ratio of 97.4:1.4:1.2, with deionized water added as a solvent; and uniformly stirred under the action of a vacuum mixer to obtain a negative electrode slurry with a solid content of 50 wt %. The negative electrode slurry was uniformly applied to one surface of a negative electrode current collector copper foil with a thickness of 10 μm, dried at 85° C., and cold-pressed to obtain a negative electrode with a single side coated with a negative electrode material layer with a coating thickness of 130 μm. Then, the above steps were repeated on another surface of the copper foil to obtain a negative electrode with two sides coated with negative electrode material layers. After cutting and welding a negative tab, which was a nickel tab, a negative electrode plate with a specification of 76 mm×867 mm was obtained, and a compacted density of the negative electrode material layer of the negative electrode plate was 1.80 g/cm³.

### (3) Preparation of Separator

A polypropylene raw material was prepared into a polypropylene base film with a thickness D1 of 5 μm through a melting extrusion device and a thermal stretching device. A ceramic layer 22 with a thickness D2 of 2 μm was applied to two sides of the base film 21 respectively. After the coating was completed, an adhesive layer 23 was applied to a side of the ceramic layer 22 away from the base film 21, a thickness D3 of the adhesive layer 23 was 1 μm, and the obtained separator was cut to obtain a separator with a specification of 80 mm×880 mm. The ceramic layer 22 and the adhesive layer 23 both extend from a starting end of the separator 20 toward a terminal opposite the starting end, where the puncture strength C of the base film 21 was 100 gf, a porosity B was 50%, a particle size of ceramic particles in the ceramic layer 22 was 1.5 μm, a pore size P of the adhesive layer 23 was 150 μm, and a particle size G of adhesive particles was 1 μm.

### (4) Preparation of Electrolyte

In an argon atmosphere glove box with a water content less than 10 ppm, ethylene carbonate (EC), propylene carbonate (PC), diethyl carbonate (DEC), ethyl propionate (EP), and propyl propionate (PP) were uniformly mixed in a mass ratio of 1:1:1:1:1 to obtain a base solvent in which ethylene carbonate, dimethyl carbonate, and ethyl methyl carbonate were mixed in a ratio of 1:1:1; and then lithium hexafluorophosphate (LiPF₆) was dissolved in the above non-aqueous solvent, to obtain an electrolyte after uniformly mixing. Based on a total mass of the electrolyte, a mass percentage content of LiPF₆ was 12.5%.

### (5) Assembly of Lithium-Ion Battery

A protective insulating adhesive was attached to the positive electrode plate, and the positive tab was mounted in an edge area of the positive electrode plate 11. A roller rolled to produce the protrusions 101 on the negative electrode plate 12. The height H of the protrusions 101 was 40 μm, a diameter was 1 μm, and the negative tab was mounted in an edge area of the negative electrode plate 12.

The positive electrode plate 11 with the positive tab, the separator 20, and the negative electrode plate 12 with the negative tab were sequentially stacked, so that the separator 20 was located between the positive electrode plate 11 and the negative electrode plate 12 for isolation; and then wound to obtain an electrode body. The electrode assembly was placed in an outer packaging aluminum-plastic film, moisture was removed at 80° C., and the above electrolyte was injected followed by encapsulation. A lithium-ion battery was obtained through processes such as formation, degassing, and edge cutting. The test methods for parameters in the examples of this application are described below.

In Examples 1-1 to 1-20 and Comparative examples 1-1 to 1-4, parameters are the same as Example 1-1 except that the puncture strength C of the base film 21 in the preparation of the separator and the height H of the protrusions 101 in the assembly of the lithium-ion battery are adjusted.

In Examples 1-1 to 1-20 and Comparative examples 1-1 to 1-4, the parameters of the lithium-ion batteries and the performance test results of the lithium-ion batteries are shown in Table 1.

TABLE 1

| | | | Cycle number | Cycle number | | |
|---|---|---|---|---|---|---|
| | Puncture | | corresponding to | corresponding to | | |
| | strength C | Height H of | cycling capacity | cycling capacity | Winding | Average |
| | of base | protrusions | less than or equal | less than or equal | yield rate | K value |
| | film (gf) | (μm) | to 80% at 25° C. | to 80% at 45° C. | (%) | (mv/h) |
| Comparative | 90 | 40 | 988 | 468 | 85.0 | 0.15 |
| example 1-1 | | | | | | |
| Example 1-1 | 100 | 40 | 1582 | 581 | 95 | 0.035 |
| Example 1-2 | 150 | 40 | 1580 | 580 | 95 | 0.036 |
| Example 1-3 | 200 | 40 | 1588 | 585 | 98 | 0.032 |
| Example 1-4 | 250 | 40 | 1586 | 625 | 99.4 | 0.034 |
| Comparative | 200 | 15 | 1154 | 493 | 88.7 | 0.162 |
| example 1-2 | | | | | | |
| Example 1-5 | 200 | 20 | 1500 | 582 | 96 | 0.036 |
| Example 1-6 | 200 | 30 | 1553 | 583 | 96 | 0.038 |
| Example 1-7 | 200 | 40 | 1582 | 580 | 96 | 0.036 |
| Example 1-8 | 200 | 50 | 1682 | 589 | 96 | 0.037 |
| Example 1-9 | 200 | 60 | 1752 | 585 | 95 | 0.028 |
| Example | 200 | 65 | 1476 | 555 | 93 | 0.065 |
| 1-10 | | | | | | |
| Example | 250 | 70 | 1757 | 588 | 95 | 0.03 |
| 1-11 | | | | | | |
| Example | 300 | 70 | 1755 | 582 | 95 | 0.023 |
| 1-12 | | | | | | |
| Example | 350 | 70 | 1750 | 581 | 95 | 0.029 |
| 1-13 | | | | | | |
| Example | 400 | 70 | 1750 | 581 | 97 | 0.028 |
| 1-14 | | | | | | |
| Example | 450 | 70 | 1758 | 584 | 98 | 0.029 |
| 1-15 | | | | | | |
| Example | 500 | 70 | 1755 | 581 | 99 | 0.029 |
| 1-16 | | | | | | |
| Comparative | 510 | 70 | 1103 | 440 | 86 | 0.146 |
| example 1-3 | | | | | | |
| Example | 400 | 55 | 1404 | 531 | 93.5 | 0.066 |
| 1-17 | | | | | | |
| Example | 400 | 60 | 1582 | 580 | 95.5 | 0.035 |
| 1-18 | | | | | | |
| Example | 400 | 70 | 1680 | 581 | 95 | 0.03 |
| 1-19 | | | | | | |
| Example | 400 | 80 | 1750 | 580 | 94.5 | 0.032 |
| 1-20 | | | | | | |
| Comparative | 400 | 85 | 1103 | 445 | 88 | 0.168 |
| example 1-4 | | | | | | |

From Examples 1-1 to 1-4, 1-11 to 1-16, Comparative example 1-1, and Comparative example 1-3 in Table 1, it can be learned that when the puncture strength C of the lithium-ion battery satisfies 100≤C≤500, the lithium-ion battery exhibits good charge-discharge cycling performance at 25° C. and 45° C., while the winding yield rate and K value performance are ensured.

From Examples 1-5 to 1-10 and Comparative examples 1-2 and 1-3 in Table 1, it can be learned that when the lithium-ion battery satisfies 100≤C<250 and 20≤H<60, the puncture strength C of the base film 21 matches the height H of the protrusions 101, so that the mechanical strength of the base film 21 is sufficient to withstand the stress generated by powder falling from the electrode plate 10, alleviating piercing of the separator 20 by powder; further the protrusions 101 can provide sufficient support for the separator 20, and the electrolyte can flow smoothly between the protrusions 101, achieving better electrolyte retention, improving the electrolyte infiltration effect. The lithium-ion battery exhibits better charge-discharge cycling performance at 25° C. and 45° C., while the winding yield rate and K value performance are ensured.

From Examples 1-11 to 1-16 and Comparative example 1-3 in Table 1, it can be learned that when the lithium-ion battery satisfies 250≤C≤500 and 60≤H≤80, the base film 21 has higher mechanical strength to cope with the stress concentration generated by higher protrusions 101, improving the stability of the lithium-ion battery. In this case, the lithium-ion battery exhibits better charge-discharge cycling performance at 25° C. and 45° C., the winding yield rate of the lithium-ion battery is improved, and K value performance is ensured.

In Examples 2-1 to 2-20 and Comparative examples 2-1 to 2-3, the parameters are the same as Example 1-8 except that the thickness D1 of the ceramic layer 22 in the preparation of the separator and the height H of the protrusions 101 in the assembly of the lithium-ion battery are adjusted.

In Example 1-8, Examples 2-1 to 2-20, and Comparative examples 2-1 to 2-3, the parameters of the lithium-ion batteries and the performance test results of the lithium-ion batteries are shown in Table 2.

TABLE 2

| | | | Cycle number | Cycle number | | |
|---|---|---|---|---|---|---|
| | Thickness | | corresponding to | corresponding to | | |
| | D1 of | Height H of | cycling capacity | cycling capacity | Winding | Average K |
| | ceramic | protrusions | less than or equal | less than or equal | yield rate | value |
| | layer (μm) | (μm) | to 80% at 25° C. | to 80% at 45° C. | (%) | (mv/h) |
| Example 1-8 | 2 | 50 | 1682 | 589 | 96 | 0.037 |
| Comparative | 0.5 | 15 | 1060 | 425 | 90 | 0.168 |
| example 2-1 | | | | | | |
| Example 2-1 | 1 | 40 | 1588 | 581 | 95 | 0.032 |
| Example 2-2 | 1.5 | 40 | 1580 | 586 | 95.5 | 0.032 |
| Example 2-3 | 2 | 40 | 1586 | 581 | 96 | 0.036 |
| Example 2-4 | 2.5 | 40 | 1580 | 589 | 96.5 | 0.038 |
| Example 2-5 | 3 | 40 | 1589 | 585 | 98 | 0.036 |
| Comparative | 2 | 15 | 1205 | 420 | 87.8 | 0.175 |
| example 2-2 | | | | | | |
| Example 2-6 | 2 | 20 | 1505 | 589 | 95 | 0.036 |
| Example 2-7 | 2 | 30 | 1550 | 588 | 95 | 0.037 |
| Example 2-8 | 2 | 40 | 1583 | 586 | 95 | 0.039 |
| Example 2-9 | 2 | 50 | 1683 | 580 | 95 | 0.034 |
| Example | 2 | 60 | 1750 | 583 | 95 | 0.03 |
| 2-10 | | | | | | |
| Example | 2 | 65 | 1406 | 493 | 93 | 0.058 |
| 2-11 | | | | | | |
| Example | 3 | 70 | 1689 | 581 | 96 | 0.036 |
| 2-12 | | | | | | |
| Example | 4 | 70 | 1686 | 583 | 97 | 0.035 |
| 2-13 | | | | | | |
| Example | 5 | 70 | 1680 | 584 | 98 | 0.037 |
| 2-14 | | | | | | |
| Example | 6 | 70 | 1684 | 580 | 99 | 0.036 |
| 2-15 | | | | | | |
| Example | 6.5 | 70 | 1350 | 488 | 95 | 0.064 |
| 2-16 | | | | | | |
| Example | 5 | 55 | 1400 | 485 | 93 | 0.036 |
| 2-17 | | | | | | |
| Example | 5 | 60 | 1686 | 586 | 96 | 0.035 |
| 2-18 | | | | | | |
| Example | 5 | 70 | 1683 | 589 | 96 | 0.03 |
| 2-19 | | | | | | |
| Example | 5 | 80 | 1752 | 604 | 96 | 0.033 |
| 2-20 | | | | | | |
| Comparative | 5 | 85 | 1152 | 420 | 89.6 | 0.154 |
| example 2-3 | | | | | | |

From Examples 2-1 to 2-5, 2-12 to 2-16, Comparative example 2-1 and Comparative example 2-2 in Table 2, it can be learned that when the thickness D1 of the ceramic layer 22 of the lithium-ion battery satisfies 1≤D1≤6, the lithium-ion battery exhibits good charge-discharge cycling performance at 25° C. and 45° C., while the winding yield rate and K value performance are ensured.

From Examples 2-6 to 2-11 and Comparative examples 2-2 and 2-3 in Table 2, it can be learned that when the lithium-ion battery satisfies 1≤D1<3 and 20≤H<60, the base film 21 can form an effective barrier, reducing the risk of short circuit due to contact between positive and negative electrode plates, maintaining the structural stability of the battery. In this case, the lithium-ion battery exhibits better charge-discharge cycling performance at 25° C. and 45° C., the winding yield rate of the lithium-ion battery is improved, and K value performance is ensured.

From Examples 2-12 to 2-16 and Comparative example 2-3 in Table 2, it can be learned that when the lithium-ion battery satisfies 3≤D1≤6 and 60≤H≤80, the base film 21 has higher mechanical strength to cope with the stress concentration generated by higher protrusions 101. In this case, the lithium-ion battery exhibits better charge-discharge cycling performance at 25° C. and 45° C., the winding yield rate of the lithium-ion battery is improved, and K value performance is ensured.

In Examples 3-1 to 3-27, the parameters are the same as Example 1-1 except that the thickness D2 of the base film 21 in the preparation of the separator and the height H of the protrusions 101 in the assembly of the lithium-ion battery are adjusted.

In Example 1-8 and Examples 3-1 to 3-27, the parameters of the lithium-ion batteries and the performance test results of the lithium-ion batteries are shown in Table 3.

TABLE 3

| | | | Cycle number | Cycle number | | |
|---|---|---|---|---|---|---|
| | | | corresponding to | corresponding to | | |
| | Thickness | Height H of | cycling capacity | cycling capacity | Winding | Average K |
| | D2 of base | protrusions | less than or equal | less than or equal | yield rate | value |
| | film (μm) | (μm) | to 80% at 25° C. | to 80% at 45° C. | (%) | (mv/h) |
| Example 1-8 | 5 | 50 | 1682 | 589 | 96 | 0.037 |
| Example 3-1 | 4 | 40 | 1582 | 583 | 95 | 0.035 |
| Example 3-2 | 5 | 40 | 1580 | 584 | 96 | 0.032 |
| Example 3-3 | 6 | 40 | 1588 | 586 | 97 | 0.032 |
| Example 3-4 | 7 | 40 | 1586 | 580 | 98 | 0.036 |
| Example 3-5 | 4 | 20 | 1505 | 589 | 95 | 0.038 |
| Example 3-6 | 4 | 30 | 1554 | 580 | 95 | 0.036 |
| Example 3-7 | 4 | 40 | 1584 | 586 | 95 | 0.034 |
| Example 3-8 | 4 | 50 | 1680 | 587 | 95 | 0.036 |
| Example 3-9 | 4 | 60 | 1448 | 546 | 94 | 0.066 |
| Example | 6 | 20 | 1500 | 584 | 96 | 0.039 |
| 3-10 | | | | | | |
| Example | 6 | 30 | 1557 | 583 | 96 | 0.034 |
| 3-11 | | | | | | |
| Example | 6 | 40 | 1580 | 582 | 96 | 0.032 |
| 3-12 | | | | | | |
| Example | 6 | 50 | 1685 | 586 | 96 | 0.034 |
| 3-13 | | | | | | |
| Example | 6 | 60 | 1470 | 558 | 94 | 0.058 |
| 3-14 | | | | | | |
| Example | 7 | 70 | 1504 | 587 | 96 | 0.035 |
| 3-15 | | | | | | |
| Example | 9 | 70 | 1550 | 588 | 96 | 0.037 |
| 3-16 | | | | | | |
| Example | 11 | 70 | 1584 | 586 | 96 | 0.036 |
| 3-17 | | | | | | |
| Example | 14 | 70 | 1680 | 584 | 96 | 0.064 |
| 3-18 | | | | | | |
| Example | 8 | 60 | 1586 | 583 | 96 | 0.036 |
| 3-19 | | | | | | |
| Example | 8 | 70 | 1680 | 583 | 96 | 0.035 |
| 3-20 | | | | | | |
| Example | 8 | 80 | 1685 | 583 | 95 | 0.03 |
| 3-21 | | | | | | |
| Example | 12 | 60 | 1584 | 585 | 96 | 0.043 |
| 3-22 | | | | | | |
| Example | 12 | 70 | 1688 | 586 | 96 | 0.035 |
| 3-23 | | | | | | |
| Example | 12 | 80 | 1755 | 607 | 96 | 0.035 |
| 3-24 | | | | | | |
| Example | 18 | 40 | 1468 | 553 | 93 | 0.056 |
| 3-25 | | | | | | |
| Example | 1 | 40 | 1457 | 566 | 93 | 0.06 |
| 3-26 | | | | | | |
| Example | 8 | 55 | 1389 | 528 | 93 | 0.063 |
| 3-27 | | | | | | |
| Comparative | 5 | 85 | 987 | 452 | 86 | 0.175 |
| example 3-1 | | | | | | |

From Examples 3-1 to 3-4 and 3-15 to 3-18 in Table 3, it can be learned that when the thickness D2 of the base film 21 of the lithium-ion battery satisfies 4≤D2≤14, the lithium-ion battery exhibits good charge-discharge cycling performance at 25° C. and 45° C., while the winding yield rate and K value performance are ensured.

From Examples 3-5 to 3-9 and 3-10 to 3-14 in Table 3, it can be learned that when the lithium-ion battery satisfies 4≤D2<7 and 20≤H<60, lower protrusions 101 match a thinner base film 21, so that the base film 21 has an appropriate internal resistance, avoiding unnecessary loss of energy density and power density of the battery. From Examples 3-19 to 3-21 and 3-22 to 3-27 in Table 3, it can be learned that when the lithium-ion battery satisfies 7≤D2≤14 and 60≤H≤80, the base film 21 has higher mechanical strength to cope with the stress concentration generated by higher protrusions 101. With D2 and H satisfying the above ranges, the lithium-ion battery exhibits better charge-discharge cycling performance at 25° C. and 45° C., the winding yield rate of the lithium-ion battery is improved, and K value performance is ensured.

In Examples 4-1 to 4-16, the parameters are the same as Example 1-1 except that the porosity B of the base film 21 in the preparation of the separator and the height H of the protrusions 101 in the assembly of the lithium-ion battery are adjusted.

In Example 1-8 and Examples 4-1 to 4-16, the parameters of the lithium-ion batteries and the performance test results of the lithium-ion batteries are shown in Table 4.

TABLE 4

| | | | Cycle number | Cycle number | | |
|---|---|---|---|---|---|---|
| | | | corresponding to | corresponding to | | |
| | Porosity B | Height H of | cycling capacity less | cycling capacity | Winding | Average |
| | of base | protrusions | than or equal to 80% | less than or equal | yield rate | K value |
| | film (%) | (μm) | at 25° C. | to 80% at 45° C. | (%) | (mv/h) |
| Example 1-8 | 50 | 50 | 1682 | 589 | 96 | 0.037 |
| Example 4-1 | 40 | 40 | 1580 | 560 | 97 | 0.036 |
| Example 4-2 | 45 | 40 | 1580 | 566 | 97 | 0.03 |
| Example 4-3 | 50 | 40 | 1580 | 568 | 96 | 0.034 |
| Example 4-4 | 55 | 40 | 1650 | 604 | 95 | 0.035 |
| Example 4-5 | 60 | 40 | 1420 | 528 | 93 | 0.064 |
| Example 4-6 | 40 | 20 | 1500 | 583 | 96 | 0.036 |
| Example 4-7 | 40 | 30 | 1555 | 583 | 96 | 0.034 |
| Example 4-8 | 40 | 40 | 1586 | 582 | 96 | 0.036 |
| Example 4-9 | 40 | 50 | 1680 | 586 | 96 | 0.037 |
| Example 4-10 | 40 | 60 | 1758 | 586 | 96 | 0.037 |
| Example 4-11 | 20 | 70 | 1624 | 588 | 96 | 0.034 |
| Example 4-12 | 30 | 70 | 1637 | 600 | 96 | 0.03 |
| Example 4-13 | 40 | 70 | 1640 | 605 | 96 | 0.034 |
| Example 4-14 | 20 | 60 | 1628 | 580 | 96 | 0.038 |
| Example 4-15 | 20 | 70 | 1650 | 607 | 96 | 0.035 |
| Example 4-16 | 20 | 80 | 1684 | 600 | 96 | 0.032 |

From Examples 4-1 to 4-5, 4-10 to 4-12, and 1-8 in Table 4, it can be learned that when the porosity B of the base film 21 of the lithium-ion battery satisfies 20%≤B≤55%, the lithium-ion battery exhibits good charge-discharge cycling performance at 25° C. and 45° C., while the winding yield rate and K value performance are ensured.

It can be learned that from Examples 4-6 to 4-10 in Table 4, when the lithium-ion battery satisfies 40%≤B≤55% and 20≤H<60, and from Examples 4-14 to 4-16 in Table 4, when the lithium-ion battery satisfies 20%≤B<40% and 60≤H≤80, with D2 and H satisfying the above ranges, the uniform distribution of pores in the base film 21 can promote uniform ion transport, ensuring the consistency of the interface performance between the electrode plate 10 and the electrolyte, alleviating the generation of lithium dendrites, thereby improving the safety of the battery. In this case, the lithium-ion battery exhibits better charge-discharge cycling performance at 25° C. and 45° C., the winding yield rate of the lithium-ion battery is improved, and K value performance is ensured.

In Examples 5-1 to 5-18, the parameters are the same as Example 1-1 except that the thickness D3 of the adhesive layer 23 in the preparation of the separator and the height H of the protrusions 101 in the assembly of the lithium-ion battery are adjusted.

In Example 1-8 and Examples 5-1 to 5-18, the parameters of the lithium-ion batteries and the performance test results of the lithium-ion batteries are shown in Table 5.

TABLE 5

| | | | Cycle number | Cycle number | | |
|---|---|---|---|---|---|---|
| | Thickness | | corresponding to | corresponding to | | |
| | D3 of | Height H of | cycling capacity | cycling capacity | Winding | |
| | adhesive | protrusions | less than or equal | less than or equal | yield rate | Average K |
| | layer (μm) | (μm) | to 80% at 25° C. | to 80% at 55° C. | (%) | value (mv/h) |
| Example 1-8 | 1 | 50 | 1682 | 589 | 96 | 0.037 |
| Example 5-1 | 0.5 | 40 | 1580 | 560 | 97 | 0.036 |
| Example 5-2 | 1 | 40 | 1556 | 569 | 97 | 0.033 |
| Example 5-3 | 1.5 | 40 | 1587 | 565 | 96 | 0.037 |
| Example 5-4 | 2 | 40 | 1658 | 603 | 95 | 0.035 |
| Example 5-5 | 1.5 | 20 | 1500 | 580 | 97 | 0.045 |
| Example 5-6 | 1.5 | 30 | 1553 | 585 | 97 | 0.032 |
| Example 5-7 | 1.5 | 40 | 1583 | 584 | 97 | 0.032 |
| Example 5-8 | 1.5 | 50 | 1683 | 580 | 97 | 0.034 |
| Example 5-9 | 1.5 | 60 | 1753 | 580 | 96.5 | 0.037 |
| Example | 1.5 | 70 | 1478 | 562 | 94 | 0.059 |
| 5-10 | | | | | | |
| Example | 2 | 70 | 1620 | 585 | 97.5 | 0.034 |
| 5-11 | | | | | | |
| Example | 3 | 70 | 1634 | 600 | 97.5 | 0.032 |
| 5-12 | | | | | | |
| Example | 4 | 70 | 1646 | 603 | 97.5 | 0.033 |
| 5-13 | | | | | | |
| Example | 5 | 70 | 1640 | 600 | 97.5 | 0.035 |
| 5-14 | | | | | | |
| Example | 4 | 60 | 1629 | 583 | 97.5 | 0.035 |
| 5-15 | | | | | | |
| Example | 4 | 55 | 1464 | 546 | 93 | 0.065 |
| 5-16 | | | | | | |
| Example | 4 | 70 | 1620 | 580 | 97.5 | 0.035 |
| 5-17 | | | | | | |
| Example | 4 | 80 | 1686 | 607 | 96 | 0.037 |
| 5-18 | | | | | | |

From Examples 5-1 to 5-5 and 5-11 to 5-14 in Table 5, it can be learned that when the thickness D3 of the adhesive layer 23 of the lithium-ion battery satisfies 0.5≤D3≤5, the lithium-ion battery exhibits good charge-discharge cycling performance at 25° C. and 55° C., while the winding yield rate and K value performance are ensured.

It can be learned that from Examples 5-5 to 5-10 in Table 5, when the lithium-ion battery satisfies 0.5≤D3<2 and 20≤H<60, and from Examples 5-15 to 5-18 in Table 5, when the lithium-ion battery satisfies 2≤D3≤5 and 60≤H≤80, with D2 and H satisfying the above ranges, the height of the protrusions 101 matches the thickness of the adhesive layer 23, and the adhesive layer 23 exhibits good adhesive performance, improving the contact interface between the separator 20 and the electrode plate 10, improving the consistency of the battery; and the adhesive layer 23 can buffer the local pressure caused by the protrusions 101, reducing the risk of piercing the separator 20. In this case, the lithium-ion battery exhibits better charge-discharge cycling performance at 25° C. and 55° C., the winding yield rate of the lithium-ion battery is improved, and K value performance is ensured.

In Example 1-8 and Examples 6-1 to 6-36, the parameters are the same as Example 1-1 except that the pore size P of the adhesive layer in the preparation of the separator and the height H and diameter R of the protrusions 101 in the assembly of the lithium-ion battery are adjusted.

In Example 1-8 and Examples 6-1 to 6-36, the parameters of the lithium-ion batteries and the performance test results of the lithium-ion batteries are shown in Table 6.

TABLE 6

| | | | | Cycle number | Cycle number | | |
|---|---|---|---|---|---|---|---|
| | | | | corresponding to | corresponding | | |
| | | | Diameter R | cycling capacity | to cycling | | |
| | Pore size P | Height H of | of | less than or | capacity less | Winding | Average |
| | of adhesive | protrusions | protrusions | equal to 80% at | than or equal to | yield rate | K value |
| | layer (μm) | (μm) | (mm) | 25° C. | 80% at 65° C. | (%) | (mv/h) |
| Example 1-8 | 150 | 50 | 1 | 1682 | 589 | 96 | 0.037 |
| Example 6-1 | 100 | 40 | 1 | 1582 | 560 | 97 | 0.034 |
| Example 6-2 | 150 | 40 | 1 | 1580 | 560 | 97 | 0.036 |
| Example 6-3 | 200 | 40 | 1 | 1582 | 565 | 96.5 | 0.036 |
| Example 6-4 | 250 | 40 | 1 | 1583 | 568 | 96.5 | 0.037 |
| Example 6-5 | 300 | 40 | 1 | 1586 | 565 | 96 | 0.03 |
| Example 6-6 | 350 | 40 | 1 | 1397 | 538 | 93.2 | 0.062 |
| Example 6-7 | 150 | 20 | 1 | 1506 | 583 | 96 | 0.035 |
| Example 6-8 | 150 | 30 | 1 | 1558 | 580 | 96 | 0.036 |
| Example 6-9 | 150 | 40 | 1 | 1580 | 580 | 96 | 0.038 |
| Example | 150 | 50 | 1 | 1680 | 582 | 96 | 0.039 |
| 6-10 | | | | | | | |
| Example | 150 | 60 | 1 | 1754 | 588 | 96 | 0.03 |
| 6-11 | | | | | | | |
| Example | 150 | 65 | 1 | 1468 | 553 | 94 | 0.068 |
| 6-12 | | | | | | | |
| Example | 150 | 40 | 0.3 | 1500 | 589 | 96 | 0.035 |
| 6-13 | | | | | | | |
| Example | 150 | 40 | 0.6 | 1555 | 586 | 96 | 0.038 |
| 6-14 | | | | | | | |
| Example | 150 | 40 | 1 | 1580 | 585 | 96 | 0.035 |
| 6-15 | | | | | | | |
| Example | 150 | 40 | 1.5 | 1686 | 580 | 96 | 0.032 |
| 6-16 | | | | | | | |
| Example | 150 | 40 | 2 | 1750 | 580 | 96 | 0.031 |
| 6-17 | | | | | | | |
| Example | 150 | 40 | 2.5 | 1489 | 528 | 94.8 | 0.078 |
| 6-18 | | | | | | | |
| Example | 0.5 | 70 | 5 | 1367 | 495 | 96 | 0.079 |
| 6-19 | | | | | | | |
| Example | 10 | 70 | 5 | 1624 | 584 | 97.5 | 0.035 |
| 6-20 | | | | | | | |
| Example | 30 | 70 | 5 | 1634 | 609 | 97.5 | 0.032 |
| 6-21 | | | | | | | |
| Example | 50 | 70 | 5 | 1643 | 604 | 97.5 | 0.033 |
| 6-22 | | | | | | | |
| Example | 70 | 70 | 5 | 1640 | 606 | 97.5 | 0.036 |
| 6-23 | | | | | | | |
| Example | 100 | 70 | 5 | 1645 | 605 | 97 | 0.035 |
| 6-24 | | | | | | | |
| Example | 120 | 70 | 5 | 1488 | 525 | 92.8 | 0.067 |
| 6-25 | | | | | | | |
| Example | 50 | 60 | 5 | 1626 | 580 | 97.5 | 0.038 |
| 6-26 | | | | | | | |
| Example | 50 | 70 | 5 | 1624 | 585 | 97.5 | 0.032 |
| 6-27 | | | | | | | |
| Example | 50 | 80 | 5 | 1683 | 600 | 96 | 0.034 |
| 6-28 | | | | | | | |
| Example | 50 | 55 | 5 | 1500 | 546 | 92.6 | 0.058 |
| 6-29 | | | | | | | |
| Example | 50 | 70 | 2 | 1622 | 582 | 97.5 | 0.035 |
| 6-30 | | | | | | | |
| Example | 50 | 70 | 4 | 1630 | 603 | 97.5 | 0.035 |
| 6-31 | | | | | | | |
| Example | 50 | 70 | 6 | 1642 | 604 | 97.5 | 0.036 |
| 6-32 | | | | | | | |
| Example | 50 | 70 | 8 | 1620 | 594 | 97.5 | 0.036 |
| 6-33 | | | | | | | |
| Example | 50 | 70 | 10 | 1605 | 602 | 97.5 | 0.038 |
| 6-34 | | | | | | | |
| Example | 50 | 70 | 12 | 1397 | 523 | 93.2 | 0.065 |
| 6-35 | | | | | | | |
| Example | 50 | 70 | 1 | 1388 | 535 | 93.4 | 0.075 |
| 6-36 | | | | | | | |

From Examples 6-1 to 6-6 and 6-19 to 6-25 in Table 6, it can be learned that when the pore size P of the adhesive layer 23 of the lithium-ion battery satisfies the range in this application, the lithium-ion battery exhibits good charge-discharge cycling performance at 25° C. and 65° C., while the winding yield rate and K value performance are ensured.

From Table 6, it can be learned that when the lithium-ion battery satisfies 100<P≤300, 20≤H<60, and 0.3 mm≤R<2 mm, or the lithium-ion battery satisfies 0.5≤P≤100, 60≤H≤80, and 2<R≤10, the air permeability and mechanical performance of the adhesive layer 23 are balanced, thereby improving the ion transport performance and puncture resistance of the separator 20. Within the above ranges, it is convenient to control the area occupied by the protrusions 101 within an appropriate range, preventing the area occupied by the protrusions 101 from being excessively large or excessively small, so that the protrusions 101 can satisfy requirements for the electrolyte infiltration and support strength. In this case, the lithium-ion battery exhibits better charge-discharge cycling performance at 25° C. and 65° C., the winding yield rate of the lithium-ion battery is improved, and K value performance is ensured.

From the examples in Table 6, it can be learned that based on the height of the protrusions 101 and the diameter of the protrusions 101, the sharp shape of the protrusions 101 is avoided to prevent damage to the separator 20, and the protrusions 101 is prevented from occupying an excessively large area, resulting in an insufficient infiltration space after winding. In this case, the lithium-ion battery exhibits better charge-discharge cycling performance at 25° C. and 65° C., the winding yield rate of the lithium-ion battery is improved, and K value performance is ensured.

In the drawings of these embodiments, the same or similar reference signs correspond to the same or similar components; in the description of this application, it should be understood that if terms such as “upper”, “lower”, “left”, and “right” indicate an orientation or positional relationship based on the orientation or positional relationship shown in the drawings, it is only for the convenience of describing this application and simplifying the description, rather than indicating or implying that the referred apparatus or element must have a specific orientation, or be constructed and operated in a specific orientation, therefore the terms describing the positional relationship in the drawings are only for exemplary illustration and cannot be understood as a limitation on the present patent. For those of ordinary skill in the art, the specific meaning of the above terms can be understood according to specific situations.

The above embodiments are only preferred embodiments of this application and are not intended to limit this application. Any modification, equivalent replacement, and improvement made within the spirit and principles of this application shall be included in the protection scope of this application.

What is claimed is:

1. An electrode assembly, wherein the electrode assembly comprises a plurality of electrode plates and a separator disposed between two of the electrode plates of opposite polarities; at least one of the electrode plates has a plurality of protrusions; the protrusions have a height H (μm); and 20≤H≤80; and
the separator comprises a base film and a ceramic layer disposed on the base film, and the ceramic layer is provided on a side of the base film along a thickness direction; wherein the base film has a puncture strength C (gf), the ceramic layer has a thickness D1 (μm), 100≤C≤500, and 1≤D1≤6.

2. The electrode assembly according to claim 1, wherein the electrode assembly satisfies one of the following conditions:
$$100 \leq C < 250 , and 20 \leq H < 60 ; \qquad ( 1 )$$
$$or$$
$$250 \leq C \leq 500 , and 60 \leq H \leq 80. \qquad ( 2 )$$

3. The electrode assembly according to claim 1, wherein the electrode assembly satisfies one of the following conditions:
$$1 \leq D 1 < 3 , and 20 \leq H < 60 ; \qquad ( 1 )$$
$$or$$
$$3 \leq D 1 \leq 6 , and 60 \leq H \leq 80. \qquad ( 2 )$$

4. The electrode assembly according to claim 1, wherein
the base film has a thickness D2 (μm), and 4≤D2≤14; and
the base film has a porosity B (%), and 20≤B≤55.

5. The electrode assembly according to claim 4, wherein the electrode assembly satisfies one of the following conditions:
$$4 \leq D 2 < 7 , and 20 \leq H < 60 ; \qquad ( 1 )$$
$$and$$
$$7 \leq D 2 \leq 14 , and 60 \leq H \leq 80. \qquad ( 2 )$$

6. The electrode assembly according to claim 4, wherein the electrode assembly satisfies one of the following conditions:
$$40 \leq B \leq 55 , and 20 \leq H < 60 ; \qquad ( 1 )$$
$$and$$
$$20 \leq B < 40 , and 60 \leq H \leq 80. \qquad ( 2 )$$

7. The electrode assembly according to claim 1, wherein
at least one of the plurality of electrode plates is a negative electrode plate; and
the separator comprises one or two ceramic layers, and along the thickness direction of the base film, at least one ceramic layer is provided on a side of the base film facing the negative electrode plate.

8. The electrode assembly according to claim 1, wherein the separator further comprises an adhesive layer, the adhesive layer is adhered to the base film or the ceramic layer, and the adhesive layer is further adhesively connected to the electrode plate; wherein
the adhesive layer has a thickness D3 (μm), and the electrode assembly satisfies one of the following conditions:
$$0.5 \leq D 3 < 2 , and 20 \leq H < 60 ; \qquad ( 1 )$$
$$or$$
$$2 \leq D 3 \leq 5 , and 60 \leq H \leq 80. \qquad ( 2 )$$

9. The electrode assembly according to claim 8, wherein the adhesive layer is a porous structure, the adhesive layer has a pore size P (μm), and the protrusions have a diameter R (mm); and
the electrode assembly satisfies one of the following conditions:
$$100 < P \leq 300 , 20 \leq H < 60 , and 0.3 \leq R < 2 ; \qquad ( 1 )$$
$$or$$
$$0.5 \leq P \leq 100 , 60 \leq H \leq 80 , and 2 < R \leq 10. \qquad ( 2 )$$

10. The electrode assembly according to claim 1, wherein the at least one electrode plate comprises a main body, and each protrusion is formed by a portion of the at least one electrode plate protruding toward a side in a thickness direction of the main body.

11. The electrode assembly according to claim 1, wherein the at least one electrode plate comprises a main body, in a thickness direction of the at least one electrode plate, all the protrusions are bent toward a same side of the main body, or
in a thickness direction of the electrode plate, some protrusions are bent toward one side of the main body, and other protrusions are bent toward another side of the main body.

12. A battery, comprising:
a case; and
an electrode assembly; wherein the electrode assembly comprises a plurality of electrode plates and a separator disposed between two of the electrode plates of opposite polarities; at least one of the electrode plates has a plurality of protrusions; the protrusions have a height H (μm); and 20≤H≤80; and
the separator comprises a base film and a ceramic layer disposed on the base film, and the ceramic layer is provided on a side of the base film along a thickness direction; wherein the base film has a puncture strength C (gf), the ceramic layer has a thickness D1 (μm), 100≤C≤500, and 1≤D1≤6.

13. The battery according to claim 12, wherein the electrode assembly satisfies one of the following conditions:
$$100 \leq C < 250 , and 20 \leq H < 60 ; \qquad ( 1 )$$
$$or$$
$$250 \leq C \leq 500 , and 60 \leq H \leq 80. \qquad ( 2 )$$

14. The battery according to claim 12, wherein the electrode assembly satisfies one of the following conditions:
$$1 \leq D 1 < 3 , and 20 \leq H < 60 ; \qquad ( 1 )$$
$$or$$
$$3 \leq D 1 \leq 6 , and 60 \leq H \leq 80. \qquad ( 2 )$$

15. The battery according to claim 12, wherein the base film has a thickness D2 (μm), and 4≤D2≤14; and
the base film has a porosity B (%), and 20≤B≤55.

16. The battery according to claim 15, wherein the electrode assembly satisfies one of the following conditions:
$$4 \leq D 2 < 7 , and 20 \leq H < 60 ; \qquad ( 1 )$$
$$and$$
$$7 \leq D 2 \leq 14 , and 60 \leq H \leq 80. \qquad ( 2 )$$

17. The battery according to claim 15, wherein the electrode assembly satisfies one of the following conditions:
$$40 \leq B \leq 55 , and 20 \leq H < 60 ; \qquad ( 1 )$$
$$and$$
$$20 \leq B < 40 , and 60 \leq H \leq 80. \qquad ( 2 )$$

18. The battery according to claim 12, wherein at least one of the plurality of electrode plates is a negative electrode plate; and
the separator comprises one or two ceramic layers, and along the thickness direction of the base film, at least one ceramic layer is provided on a side of the base film facing the negative electrode plate.

19. The battery according to claim 12, wherein the separator further comprises an adhesive layer, the adhesive layer is adhered to the base film or the ceramic layer, and the adhesive layer is further adhesively connected to the electrode plate; wherein
the adhesive layer has a thickness D3 (μm), and the electrode assembly satisfies one of the following conditions:
$$0.5 \leq D 3 < 2 , and 20 \leq H < 60 ; \qquad ( 1 )$$
$$or$$
$$2 \leq D 3 \leq 5 , and 60 \leq H \leq 80. \qquad ( 2 )$$

20. An electrochemical device, comprising a battery, the battery comprises an electrode assembly; wherein the electrode assembly comprises a plurality of electrode plates and a separator disposed between two of the electrode plates of opposite polarities; at least one of the electrode plates has a plurality of protrusions; the protrusions have a height H (μm); and 20≤H≤80; and
the separator comprises a base film and a ceramic layer connected to the base film, and the ceramic layer is provided on a side of the base film along a thickness direction; wherein the base film has a puncture strength C (gf), the ceramic layer has a thickness D1 (μm), 100≤C≤500, and 1≤D1≤6.
